(19) United States
(12) Patent Application Publication
(10) Pub. No.: US 2026/0079558 A1
(43) Pub. Date: Mar. 19, 2026

(54) LOGIC RETENTION SUPPORT IN A DATA PROCESSING SYSTEM

(71) Applicant: Arm Limited, Cambridge (GB)

(72) Inventors: Gergely Kiss, Budapest (HU); Csaba Kelemen, Gyor (HU); Ashley John Crawford, Ashdon (GB); Sarah Jean Kimber, Sheffield (GB)

(73) Assignee: Arm Limited, Cambridge (GB)

(21) Appl. No.: 18/888,415

(22) Filed: Sep. 18, 2024

(51) Int. Cl. G06F 1/324; G06F 1/3228

(52) U.S. Cl. CPC G06F 1/324; G06F 1/3228

(57) ABSTRACT

Logic retention support in a data processing system is provided. In a system and a methodology thereof, secondary requests are distributed based on a logic retention power mode request to functional units of a power domain by mapping the logic retention power mode request to a clock quiescence request; distributing the clock quiescence request to one or more first functional units of the functional units that are without a logic retention power mode; and maintaining the one or more first functional units in a functional power mode.

### BACKGROUND

Power modes can be implemented to cover combinations of logic and memory power states for a domain and the associated clock, reset and isolation control. For each power domain, a power controller oversees communicating power mode requests to all downstream components. These power mode requests can include logic retention power mode requests. Logic retention is applied to a circuit or component to keep the software context of the logic while it is in low power mode. When the power controller implements a logic retention state, the components of the controlled power domain need to preserve their context to provide software transparency. However, in instances in which components of a power domain do not support the logic retention power mode requests, the system cannot use an “OFF” power mode of these components when implementing logic retention as that triggers initialization or invalidation sequences and can therefore cause context loss or excessive start-up time or both.

### BRIEF DESCRIPTION OF THE DRAWINGS

The accompanying drawings provide visual representations which will be used to describe various representative embodiments more fully and can be used by those skilled in the art to understand better the representative embodiments disclosed and their inherent advantages. In these drawings, like reference numerals identify corresponding or analogous elements.

FIG. 1 depicts a functional block diagram of a logic retention support system, in accordance with an embodiment of the present disclosure.

FIG. 2 depicts a block diagram of a power control framework, in accordance with an embodiment of the present disclosure.

FIG. 3 depicts a block diagram of a distribution unit, in accordance with an embodiment of the present disclosure.

FIG. 4 is a flow chart of a method of logic retention support in a power domain, in accordance with an embodiment of the present disclosure.

FIG. 5 is a diagrammatic representation of a method of logic retention in a power domain, in accordance with an embodiment of the present disclosure.

FIG. 6 is a diagrammatic representation of a mechanism for entering a logic retention mode in a power domain of a data processing system, in accordance with an embodiment of the present disclosure.

FIG. 7 depicts a flow diagram representing functionality associated with logic retention in a power domain of a data processing system, in accordance with an embodiment of the present disclosure.

### DETAILED DESCRIPTION

Embodiments of the present disclosure will now be described with reference to the drawing figures, in which like reference numerals refer to like parts throughout.

Embodiments of the present disclosure advantageously provide a method and system for implementing logic retention support in system level power domains of a data processing system in which certain components of a domain do not support the logic retention power mode requests and the OFF power mode of these components cannot be used. For example, in certain implementations, the OFF power mode may produce results such as triggered initialization or invalidation sequences, which are contrary to achieving or maintaining software transparent logic retention, and may cause context loss or excessive start-up time or both.

There is provided an advantageous methodology, system and structure in which logic retention power mode requests need not be forwarded to all functional units or components in a power domain having components that do not support the logic retention power mode. Instead, a logic retention power mode request may be selectively distributed (sequenced in some embodiments) and selectively applied in such a power domain. Power domain components that are without a logic retention power mode are requested to enter clock quiescence to support steady state of the component.

In accordance with various embodiments presented herein, the disclosure provides a method of implementing logic retention support in a data processing system. The method may include distributing based on a logic retention power mode request one or more secondary requests to functional units in the power domain, with the distributing including mapping the logic retention power mode request to a clock quiescence request; distributing the clock quiescence request to one or more first functional units of the functional units that are without a logic retention power mode and maintaining the one or more first functional units in a functional power mode.

In accordance with various embodiments presented herein, the disclosure provides a system having a power controller of a domain and a distributor, the power controller configured to provide a logic retention power mode request to the distributor and the distributor configured to distribute one or more secondary requests to functional units in the power domain in response to receipt of the logic retention power mode request. To perform distributing, the distributor may further: map the logic retention power mode request to a clock quiescence request; distribute the clock quiescence request to one or more first functional units of the functional units that are without a logic retention power mode; and maintain the one or more first functional units in a functional power mode. These tasks may be carried out by a sequencing unit.

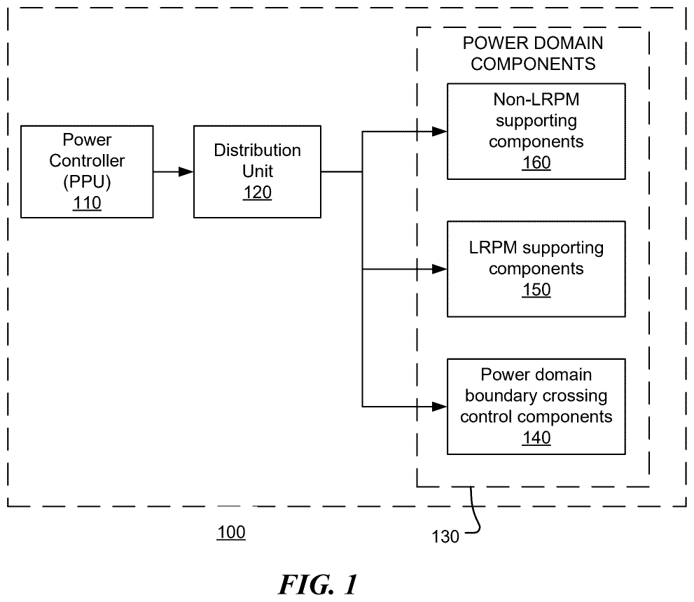

FIG. 1 is a block diagram of a logic retention support system 100, in accordance with various representative embodiments. Logic retention support system 100 may be implemented to provide logic retention support in power domains for components that do not support logic retention power mode requests and may include a power controller 110, a distribution unit 120 (distributor) and a power domain 130.

A power domain may be defined as a collection of design elements and units, such as functional units or components, within one or sometimes more voltage domain(s), that share common power control. A voltage domain is a collection of design elements supplied by a voltage source. The voltage supply to the domain might be scaled or removed for power or performance reasons. A voltage domain can have one or more power domains 130 and a power domain may itself be split into portions or partitions in which functional units or components are grouped.

Accordingly, power domain 130 may include functional units, referred to herein also as components or devices, including power domain boundary crossing control (PDBCC) components 140 such as domain bridges, logic retention power mode (LRPM) supporting components 150 such as system Interconnects, and non-LPRM supporting components 160, such as system memory management units (SMMU).

In one embodiment, logic retention support system 100 implements logic retention support in power domain 130 in order to ensure software transparent logic retention. A goal of logic retention is to keep or retain the software context of the logic while the device (component) implementing (or storing) the logic is in low power mode. It is desirable that the entry and exit of such a state is software transparent as much as possible. The methods and systems described herein provide logic retention functionality that supports fast exit from power down modes of a power domain 130.

Power domain 130 may include a power gated domain. A power gated domain is a power domain whose power can be removed by on-chip power switches. A voltage domain can then be partitioned into one or more power gated domains as well as an always-on (non-gated) power domain. Partitioning the voltage domain into several power domains 130 facilitates techniques for static leakage power mitigation. These include modes where power is removed, with loss of context, and low leakage retention modes which keep some or all contexts.

Power controller 110 implements a logic retention state where the components of the controlled power domain need to preserve their context to provide software transparency. Power management unit 110 may oversee communicating power mode requests to all downstream components in the given power domain 130. Power controller 110 may control domain power modes in coordination with device (component) clock quiescence as described herein below. As indicated below, power controller 110 may be implemented as a power policy unit (PPU) in certain embodiments.

The power controller 110 controls a distribution unit 120, also referred to as a distributor, that may receive the logic retention power mode request and selectively apply the logic retention power mode request to the components of a power domain 130. The logic retention request is not forwarded to all components in the power domain 130. Instead, distribution unit 120, based on a logic retention power mode request, may distribute one or more secondary requests to functional units or components in the power domain. The functional units can include PDBCC components 140, LRPM supporting components 150, and non-LPRM supporting components 160.

PDBCC components 140 include components within a domain that oversee power domain boundary crossings and receive the logic retention request. From the perspective of the PDBCC 140, the logic retention request may be equivalent to a power quiescence request. This guarantees that while the power domain 130 is in retention mode the interfaces are drained and fenced. The components 140 within a domain that oversee power domain boundary crossings and components 150 that can natively understand the logic retention power mode request, may be addressed sequentially in a manner that allows the implementation of the logic mode request with these logic mode retention request supporting components. These components 140 and 150 can understand the logic retention power mode request and receive the logic retention request without any specific translation or re-mapping.

Distribution unit 120 may request logic retention power mode for LPRM supporting components 140. LPRM supporting components 140 are components inside the domain that can natively understand the logic retention power mode request. These components receive the logic retention power mode request without any specific translation. In cases where there is no need for sequencing, just for distribution, distribution unit does not provide sequencing as well as distribution.

However, non-LRPM supporting components 160 do not support the logic retention power mode requests and the OFF power mode of these components cannot be used either as that triggers initialization or invalidation sequences that can cause context loss or excessive start-up time or both. These components may support simple power quiescence or OFF power mode; however, those modes cannot be used for logic retention in several cases. In many instances, the problematic components perform initialization when leaving the power quiescence or OFF power mode which causes context loss and needs software re initialization.

Distribution unit 120 may distribute, based on a logic retention power mode request received by the distribution unit 120, secondary requests to non-LRPM supporting components 160 in the power domain 130. The distributing can include mapping the logic retention power mode request to a clock quiescence request, distributing the clock quiescence request to the non-LRPM supporting components 160, and maintaining the non-LRPM supporting components 160 in a functional power mode. Distribution unit 120 does not request that the non-LRPM supporting components 160, which do not support the logic retention power mode, enter logic retention, OFF power mode or any sort of power quiescence request. This avoids triggering any invalidation or context restoration inside the given component before and after logic retention.

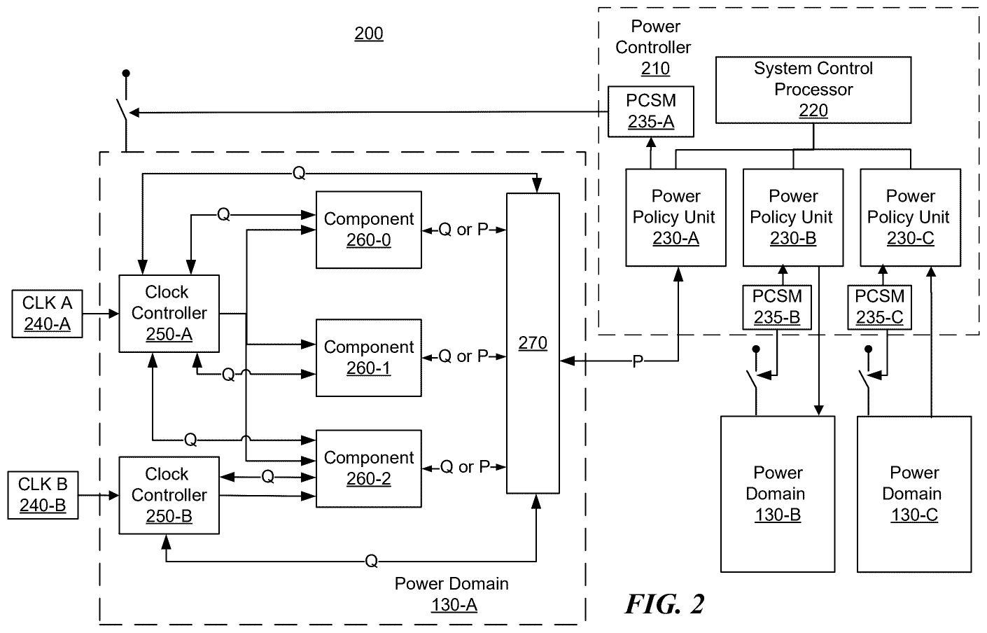

FIG. 2 depicts a block diagram of a power control framework 200, in accordance with an embodiment of the present disclosure.

The power control framework 200 may be implemented as a collection of infrastructure components, interfaces, and associated methods that can be used to build the infrastructure necessary for power management of a System-on-Chip (SoC) or other data processing system. The infrastructure components may include a power controller 210, akin to power controller 110 having power control components, such as a system control processor 220, power policy units (PPUs) 230, and power control state machines (PCSMs) 235. The PCSM in each power controller is switched to control the power supply of the respective power domain as shown. PPUs 230-A, 230-B, 230-C control power domains 130-A, 130-B, 130-C, respectively, as shown.

Each PPU of power controller 210 controls a respective power domain 130. Referring to power domain 130-A, for example, Distribution Unit (Distributor) 270 is controlled by PPU 230-A of power controller 210. Distribution Unit 270 is coupled to PPU 230-A via P-channel LPI as shown in order to receive logic retention power mode requests and in turn maps and distributes clock quiescence requests or the logic retention power mode requests to components 260-0, 260-1, 260-2 to P- or Q-Channel interfaces and CLK A 240-A and CLK B 240-B, as shown. Clocks CLK A 240-A and CLK B 240-B are received by respective clock controllers 250-A and 250-B and in turn clock components 260-0, 260-1, 260-2 as shown. Together, clock controllers 250-A, 250-B and PPUs 230-A control power and clock modes for components 260 (shown as component 260-0, 260-1 and 260-2) in power domain 130-A.

Power policy units (PPUs) 230 may be implemented as a fixed function hardware element that supports a set of power policies programmed by the system control processor 220 through a software interface and may interface with power domain components, using a low power interface (LPI) as needed to ensure safe power mode transitions.

Each PPU 230 may be paired with a PCSM 235 that abstracts the PPU's 230 power policies to implement technology specific power management, such as power switch and retention controls. This allows a PPU 230 to be re-used across multiple SoC implementations and technologies without modification.

Clock controllers 250 clocks components 260 supporting high-level clock gating. This approach enables the clock to be gated high in the clock tree when components are idle. Clock controllers 250 may be used with components that support high-level clock gating. Other infrastructure components may also be implemented to facilitate the control and combination of LPI from controllers to devices (components).

PPUs 230 may be designed to implement abstract software-controlled power domain policy down to low level hardware control signaling. This enables re-usability by separating device and technology specifics, and the provision of a common software interface. PPUs 230 may have multiple different interfaces, such as a software interface(s), a device control interface(s), and PCSM 235. A software interface may enable high-level policy control and configuration. A device control interface may enable low power level control of components (LPI) and may be used to ensure component quiescence and functional control. Accordingly, the device control interface includes interface to the devices (components) and the device controls such as clock enables, resets, and isolation control.

PPU 230 accordingly provides technology-independent hardware and software interfaces for controlling domain power modes in co-ordination with device (component) quiescence.

Local interfacing between infrastructure components like power controller 210, clock controllers 250 and functional components (devices) within a power domain may be provided by P-channel and Q-channel lower power interfaces (LPIs), including ARM™ Q-Channel and P-Channel Low Power Interfaces™. Components without support for LPI may be managed using an integration layer adaptation approach, for example.

P-channels (P-Channel or P-ch) control power state transitions and may be used to manage complex power scenarios with multiple transitions. These transitions can be made without returning the device to a common operable state.

A Q-Channel interface, conversely, may be implemented in instances where simple run-stop quiescence semantics are suitable. A Q-Channel may be a low-power interface (LPI) that controls device quiescence and simplifies clock domain crossing by making the handshake mechanism independent of the device activity indication. The Q-Channel handshake states may include Q_RUN, Q_REQUEST, and Q_STOPPED, in certain examples. With the Q_RUN interface state, the device (component) is operational. With the Q_REQUEST interface state, the device (component) is operational, but requested to become quiescent. With the Q_STOPPED interface state, the device (component) has entered the quiescent state and in this state, the availability of any clock or power supply managed by the interface is not guaranteed. Clock controllers 250 may achieve quiescence via clock Q-channel in FULL_RET power mode (as described below) to avoid any potential buffer invalidations and initialization that would prevent leverage of FULL_RET. Clock controllers 250 have a power Q-channel that is driven to quiescent state when the PPU 230 request FULL_RET. The clock controllers 250 may thereby support leverage of a full retention state FULL_RET as shown in TABLE 1 below.

PCSM 235 may enable controlling low level technology by driving power switches and retention control. The PCSM 235 may be a technology-dependent state machine for the sequencing of power switch chains and retention controls, and can include RAM and register retention. The PCSM 235 executes power mode changes under PPU direction. The interface between the PPU 230 and the PCSM 235 may be a P-Channel interface.

PPU 230 supports different power modes as shown below in TABLE 1. PPU 230 supports, at a minimum, the on (ON), warm reset (WARM_RST) and OFF (OFF) power modes. Support for other power modes and their functional equivalents is optional. PPU 230 power modes in accordance with certain embodiments are described in TABLE 1. Whether a domain contains RAM is optional.

TABLE 1

| | | Logic | RAM | |
|---|---|---|---|---|
| Power Mode | Short Name | Mode | Mode | Description |
| Debug | DBG_RECOV | ON | ON | Warm reset application with logic and RAM |
| Recovery | | | | on. May be used to |
| Reset | | | | enable reset of a component, typically when |
| | | | | locked up or non-functional, while retaining |
| | | | | some or all component state through the |
| | | | | reset for later debug analysis. |
| Warm Reset | WARM_RST | ON | ON | Warm reset application with logic and RAM |
| | | | | ON. |
| On | ON | ON | ON | Logic on with RAM ON; component is |
| | | | | functional. |
| Functional | FUNC_RET | ON | RET | Logic on with RAM retained; component is |
| Retention | | | | functional. |
| Memory Off | MEM_OFF | ON | OFF | Logic on with RAM OFF; component is |
| | | | | functional. |
| Full Retention | FULL_RET | RET | RET | Logic and RAM in retention. |
| Logic Retention | LOGIC_RET | RET | OFF | Logic retention with RAM OFF. |
| Emulated | MEM_RET_EMU | ON | ON | Logic on with RAM ON. |
| Memory | | | | This mode is used to emulate the functional |
| Retention | | | | condition of MEM_RET without removing |
| | | | | power. |
| Memory | MEM_RET | OFF | RET | Logic OFF with RAM retained. |
| Retention | | | | |
| Emulated Off | OFF_EMU | ON | ON | Logic ON with RAM ON; used to emulate |
| | | | | the functional condition of OFF without |
| | | | | removing power. |
| Off | OFF | OFF | OFF | Logic OFF and RAM OFF. |

In MEM_RET, FUNC_RET, and FULL_RET power modes, the configuration of the memory retention can be specified by software programming if the retention RAM configuration registers are supported.

In the OFF (OFF) power mode, logic and RAM are OFF and all states is lost.

In the Emulated OFF (OFF_EMU) power mode, the functional conditions of the OFF power mode are replicated, but the power to the logic and RAM remains ON. OFF_EMU differs from OFF mode by allowing some portions of the domain to be functional. For example, a processor debug state and access can be maintained while emulating the state loss, through reset of functional logic, of OFF.

In the Memory Retention (MEM_RET) power mode, logic is OFF and memory is in retention, i.e. the RAM state is retained. The scope of the retention in the power domain may be implementation defined. Retention may be either full or partial. Software may configure the extent of the memory retention.

In the Emulated Memory Retention (MEM_RET_EMU) power mode, the functional conditions of MEM_RET are replicated, but the power to the logic and RAM remains ON. The reset, and other device control application is different from MEM_RET to allow some portions of the domain to be functional. This allows, for example, processor debug state and access to be maintained while emulating the state loss, through reset of functional logic, of MEM_RET.

In the Logic Retention (LOGIC_RET) power mode, logic is non-functional, but states are retained. Logic is in retention and memory is OFF; for example, RAMs are off and RAM state is lost. Note that this mode may only be supported by a P-Channel PPU 230.

In the Full Retention (FULL_RET) power mode, logic is non-functional, but state is retained. RAM state can be retained. The scope of the retention in the domain may be implementation defined. Retention can be either full or partial. The software may configure the extent of the memory retention using the Full Retention RAM

In the Memory OFF (MEM_OFF) power mode, logic is powered ON and functional. RAMs are OFF and RAM state is lost.

In the Functional Retention (FUNC_RET) power mode, logic is powered on and functional and memory is in retention. RAM is non-functional, but state is retained. The scope of the retention in the domain may be implementation defined. Retention can be either full or partial. Software may configure the extent of the memory retention using the Functional Retention RAM.

In the ON (ON) power mode, logic and RAMs are powered on and functional.

In the Warm Reset (WARM_RST) power mode, logic and RAMs are powered ON, but specific resets are asserted.

In the Debug Recovery Reset (DBG_RECOV) power mode, logic and RAMs are powered ON, but specific resets are asserted. This power mode may be used to reset a domain in the event of a component lock-up or unexpected behavior. This mode allows a specified component state, such as memory contents, to be retained through a reset cycle for debugging purposes. This mode is supported by a P-Channel PPU 230.

PPU 230 may communicate the power mode request to all downstream components in a given power domain 130. PPU 230 may implement a logic retention state where the components of the controlled power domain 130 need to preserve their context to provide software transparency. When PPU 230 attempts to request the logic retention power mode this power mode may be treated in a different way than ON type of functional power modes or OFF type non-functional power modes.

A targeted mechanism may be implemented for OFF/MEM_RET power modes. In case of a request from the power controller (PPU 230) to enter OFF/MEM_RET power mode or power quiescence, the component receives the power mode request without translation but does not receive an explicit clock quiescence request from the same PPU 230. As used herein an “explicit” request refers to a request that is prompted by a power control request, and no explicit request means that the power transition can happen while the clock controller is in any state (quiesced, active, etc.). Only specific power transitions require the clock quiescence to happen. In other words, the power mode request does not prompt any clock quiescence of the component. This helps to reduce the surface of the unexpected power versus clock LPI dependencies. The following table shows the relation of the requested power mode at power controller side and component side with the resultant clock and power requests.

TABLE 2

| Power controller's | Component's | Component's |
|---|---|---|
| power mode request | power mode request | clock mode request |
| ON | ON | ANY |
| OFF | OFF/QUIESCENT | ANY |
| FULL_RET | ON | QUIESCENT |

This approach allows components without explicit logic retention support to preserve their context and rapidly enter exit from/to logic retention without software intervention. It also avoids potential sequencing issues between clock and power quiescence interfaces in case the clock and power interfaces have internal dependencies in the components.

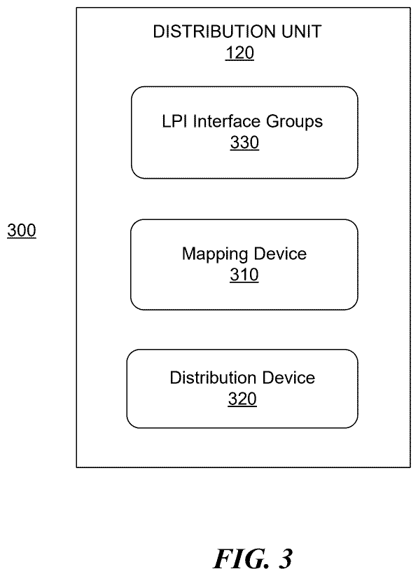

FIG. 3 depicts a block diagram 300 of an example distribution unit 120, in accordance with an embodiment of the present disclosure. As shown in FIG. 3, distribution unit 120 may include a mapping device 310, a distribution device 320 and LPI interface groupings 330 to provide mappings of components within a power domain or power domain partition. Distribution unit 120, which may be a sequencing unit, may receive a logic retention power mode request and distribute the request, such as by mapping and sequencing the request to the PDBCC components 140, LRPM supporting components 150, and non-LPRM supporting components 160 based on the LPI interface groups 330 in a manner that accounts for the components of a power domain that do not support logic retention power mode, i.e. non-LPRM supporting components 160. Non-LPRM supporting components may include, for example, components in which the PPU power mode is FUNC_RET, LOGIC_RET, or MEM_RET.

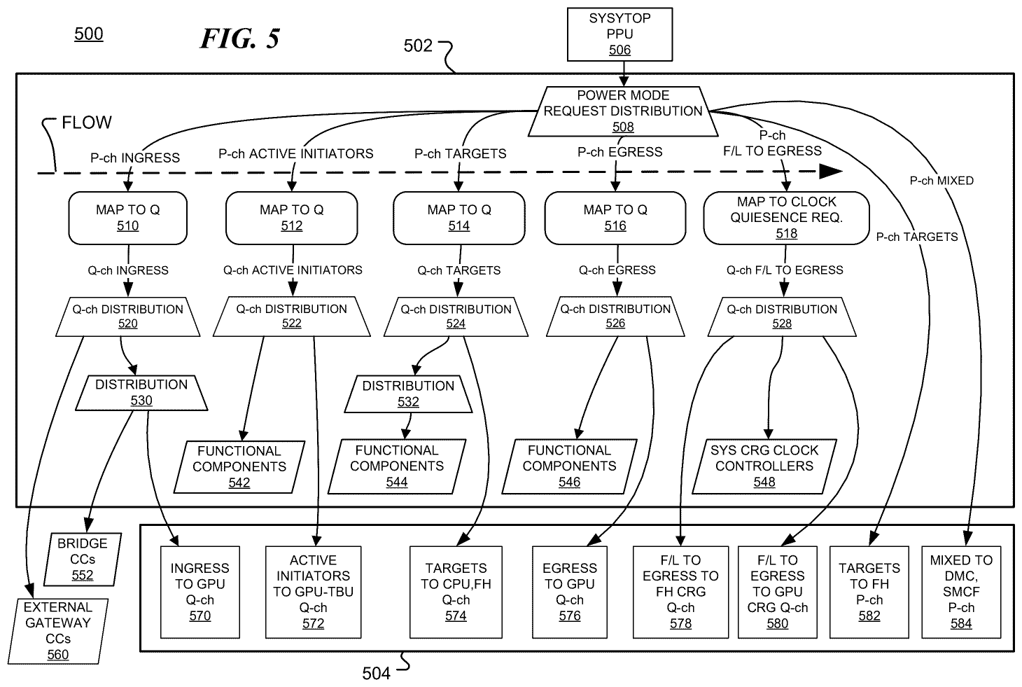

LPI interface groups 330 may be implemented to provide a grouping in each partition or section of a power domain according to sequencing requirements and thereby reduce the number of LPI channels across partitions. Based on the different component behaviors, LPI interface groups 330 may include the following: First/Last (F/L) to Egress, Egress from the top level system controlled power domain containing shared resources (PD_SYSTOP), Targets, Mixed, Active Initiators, Ingress into PD_SYSTOP, and First/Last to Ingress. These groupings of components are further illustrated and described in FIG. 5.

A First/Last (F/L) to Egress grouping may group those components for which no power handshake with any functional components is expected. This grouping may be used for clock Q-channel networks that need to be closed as part of power mode changes. This grouping may also be used for control of source synchronous output clamps. In addition, this grouping may also be used to control reset as part of the device handshake of PPU 230. As shown below with respect to FIG. 5, this group may be used on the P-Channel for controlling the clock quiescence of non-LPRM supporting components 160.

An Egress from PD_SYSTOP (the top-level system controlled power domain) grouping may group the target components (devices) on the PD_SYSTOP power domain boundary that do not actively initiate transaction but are mainly passive or reactive. This grouping protects the outside logic of these P-channel bridges from corruption and assures smooth resume from low power modes.

A Targets grouping may group target components (devices) that interconnect in the power domain and do not actively initiate transaction but mainly passive or reactive.

A Mixed grouping may group components (devices) used for expansion areas where the expansion area can have both initiators and targets. This channel can be further split to provide sequencing among expansion IP initiators and targets.

An Active Initiators grouping may group components (devices) including the ones that initiate transactions on LPI handshake and software quiesced components that do not initiate transactions on LPI.

An Ingress into PD_SYSTOP grouping may group components (devices) on the ingress paths to the PD_SYSTOP domain boundary should transition to quiescent state before any devices transition to quiescent state in the domain. This thereby protects the outside logic from losing data and provides protocol compliant termination of bus transactions targeting responder components in the domain.

A First/Last to Egress grouping may group those components (devices) that are first and last to egress.

Distribution unit 120 may receive a logic retention power mode request and cause mapping device 310 and distribution device 320 to map and sequence logic retention power mode request based on these different LPI interface groups 330 described above. The devices 310, 320 may receive and implement the logic retention power mode request in different LPI interface groups 330. For example, in certain embodiments the flow will start with Ingress, followed by Active Initiators, Targets, Egress, F/L to Egress, etc. as indicated in the dashed flow line of FIG. 5; this flow direction is valid when going from higher to lower power mode, e.g. ON to FULL_RET. Alternatively, the components (devices) may be instructed in another order that achieves the goal of the logic retention power mode request. The components that do not support the logic retention power mode are not requested to enter logic retention, OFF or any sort of power quiescence request. This avoids triggering any invalidation or context restoration inside the given component before and after logic retention. Instead, selected components in the power domain 130 that are without a logic retention power mode, i.e. that do not support the logic retention power mode, are requested to enter clock quiescence only. When going to a lower power mode this request follows all the other power mode handshakes and upon determining that the components are settled down, a global clock quiescence may be requested.

Mapping of logic retention to OFF/Quiescent power mode may break the goals of retention which are to be fast and to be software transparent. This is typically due to power OFF/Quiescent requests that trigger eviction, initialization, invalidation sequences, and disconnection/reconnection. This may cause excessive retention entry time, excessive retention exit time, and/or context loss/restoration, which are all against the goals of full retention.

The logic retention power mode request is not forwarded to all components in a power domain. Instead, it is distributed and selectively applied to components in the power domain depending on their type. Accordingly, the distribution unit 120 may not forward logic retention power mode request is to all components in the power domain 130. Instead, the distribution device 320 may distribute, such as through sequencing, and selectively apply the logic retention power mode request to the components. Components that oversee power domain boundary crossings may receive the logic retention request (which may be remapped to equivalent of a power quiescence request). This guarantees that while the power domain 130 is in retention mode the interfaces are drained and fenced. The components that are inside the power domain 130 and can natively understand the logic retention power mode request, receive the logic retention request without any specific translation.

Where the components of a power domain 130 do not support the logic retention power mode (for example, non-LRPM supporting components 160), these components are not requested to enter logic retention, OFF or power quiescence request they remain in functional power mode. This avoids triggering of any invalidation, eviction or context restoration inside the given IP before and after logic retention. Instead, all (or may be only selected) components in the power domain 130 are requested to enter clock quiescence, this guarantees steady state of the component.

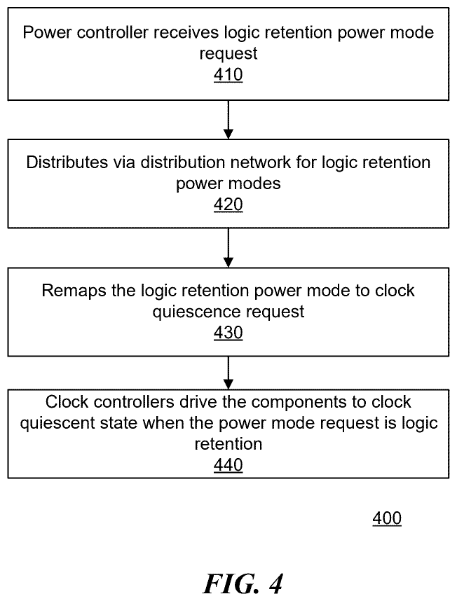

FIG. 4 depicts a flow diagram 400 representing functionality associated with implementing a logic retention request for non-LRPM supporting components 160, in accordance with an embodiment of the present disclosure.

At block 410, a power controller 110 receives a logic retention power mode request. For example, the power controller 110 may be a power controller of a power domain 130, such as a PD_SYSTOP controlled power domain. The logic retention power mode request may be sequenced and distributed to components of the power domain, including to the non-LRPM supporting components 160.

At block 420, the power controller 110 distributes, via distribution network for logic retention power modes, the logic retention request to the LRPM supporting components 150. The LRPM supporting components 150 may be mapped to a functional power mode, as shown with respect to FULL_RET in TABLE 3, below.

TABLE 3
SYSTOP PPU power modes mappings to IP power modes.

| SYSTOP PPU | TBU/TCU PWR | ITS PWR | SPI0 [symbol] |
|---|---|---|---|
| P-Ch | PWR Q-Ch | PWR Q-Ch | PWR Q-Ch |
| ON | QRUN | QRUN | QRUN |
| WARM_RST | QRUN | QRUN | QRUN |
| FULL_RET | QRUN_{#} | QRUN_{#} | QRUN |
| MEM_RET | QSTOPPED | QSTOPPED | QRUN |
| OFF | QSTOPPED | QSTOPPED | QRUN |

At block 430, the distribution unit 120 maps the logic retention power mode to clock quiescence request for the non-LRPM supporting components 160. For example, as shown in TABLE 4 below.

TABLE 4
SYSTOP0 PPU power modes mappings to CC power modes

| | | | Clock controller |
|---|---|---|---|
| | | | of Functional Units |
| SYSTOP PPU | TBU/TCU CLK | GICD CLK | (Components) |
| P-ch | CLK Q-Ch | CLK Q-Ch | PWR Q-Ch |
| ON | Any | Any | QRUN |
| WARM_RST | Any | Any | QRUN |
| FULL_RET | QSTOPPED | QSTOPPED | QSTOPPED |
| MEM_RET | Any | Any | QRUN |

At block 440, clock controllers 250 drive the components to clock quiescent state when the power mode request is logic retention.

FIG. 5 is a diagrammatic representation 500 of a method of logic retention in a power domain, in accordance with an embodiment of the present disclosure and in view of the above examples.

The power controller of the power domain 500, shown here as SYSTOP PPU 506, together with power mode request distribution unit 508 controls distribution and mapping of the logic retention power mode request to clock quiescence as needed. The power domain 500 further includes PDBCC components 140, LRPM supporting components 150, and non-LPRM supporting components 160 arranged in a number of operational paths, grouped here as Ingress, Active Initiators, then Targets, then Egress and finally First to Last F/L Egress paths. As indicated by the dashed Flow line, in certain embodiments, the functionality of the paths are implemented in order from left to right when going from higher to lower power mode, e.g. from ON to FULL RET, though other orders may be contemplated. For example, the order may be reversed if not going to low power mode. In this manner, the Ingress path may be initiated, then the Active Initiators path, followed by the Targets, Egress, First to Last (F/L) Egress, Targets and Mixed as shown. Each of the paths is controlled by the power controller of the power domain, shown here as SYSTOP PPU 506, that works in concert with a power mode request distribution network for logic retention power modes. The clock controllers are connected to the F/L Egress path to avoid any potential deadlock scenarios.

In the various paths, P-channel signaling is provided to Mapping Units 510, 512, 514, 516 to map to P-channel to Q-channel and for distribution by respective distribution units 520, 522, 524, 526, 530 and 532 to other like functional components 542, 544, 546, 570, 572, 574, 576, as shown. In the low power F/L to Egress path, P-channel signaling is provided to to Map to Clock Quiescent Request unit 518 to remap logic retention power mode requests to clock quiescent requests (P-channel to Q-Channel) for distribution by respective distribution unit 528 to other like functional components 578 and 580, as shown. SYS CRG controllers 548 in the F/L to Egress path are present to avoid potential race conditions and deadlocks in the remapping of FULL_RET to clock quiescence.

In other paths, the P-channel logic retention power mode request is not re-mapped to Q-channel; instead, the P-channel logic retention power mode request is provided directly or remapped to Q-channel QSTOPPED state and provided to the respective components in the next partition. This is shown in the P-channel Targets and P-channel Mixed paths shown on the right side of FIG. 5, which are fed directly to Targets to flexible hierarchy (FH) P-channel 582 and Mixed to Dynamic Memory Controller (DMC), System Monitoring Control Framework (SMCF) P-channel 584, respectively.

The paths shown do employ re-mapping and distribution functions within partition 502. In the Active Initiators, Targets, and Egress paths within partition 502 of the power domain 500, there are FULL_RET to power QRUN remappings. In the example implementation of this figure, the FULL_RET to clock quiescence remapping is only done for the F/L to Egress path or group and the re-mapped Q-channel clock quiescence request is driven to clock controller 548 to drive the respective components in the power domain to clock the quiescent state when the power mode request is logic retention.

Distribution blocks 522, 524, 526, 528 in the Active Initiators, Targets, Egress, and F/L to Egress paths, respectively, drive corresponding functional components 542, 544, and 546 within partition 502 as well as corresponding components further downstream in other corresponding Q-Channel groupings Active Initiators to graphical processor unit-translation buffer unit (GPU-TBU) Q-Channel 572, Targets to CPU, FH Q-Channel 574, Egress to GPU Q-Channel 576, F/L to Egress to flexible hierarchy clock and reset generation (FH CRG) Q-Channel 578, and F/L to Egress to GPU CRG Q-Channel 580, respectively, within partition 504, as shown.

In the Ingress path, the clock controller(s) (CC) need not be present within the partition 502 in this example embodiment. Rather, the remapped Q-Channel Ingress is provided to Q-channel distribution block 520 that in turn provides the request directly to a domain bridge External gateway CCs 560 as well as to domain Bridge CCs 552 via distribution unit 530 as shown. As shown, the bridge CCs 552 and 560 are bridges between partitions 502 and 504 in this embodiment. Similarly, in the Targets path remapped Q-channel requests are provided directly by Q-channel distribution block 524 to Targets to CPU, FH Q-channel 574 or it may be provided to memory functional components 544 via distribution block 532 as shown.

As discussed above, the logic retention power mode request may be sequenced and selectively distributed (applied) to the components of a power domain by a power controller PPU 506 that controls the power of the power domain. The instructions may be implemented with active remapping and power distribution, by power mode distribution unit 508 together with one or more mapping units 510, 512, 514, 516, 518 that re-map the logic retention power mode request from P-channel to Q-channel and distribute the Q-channel requests by one or more distribution units 520, 522, 524, 526, 528, 530, 532. As mentioned, the mapping block 518 of the F/L to Egress path maps the P-channel logic retention power mode request to Q-channel clock quiescence request; clock controllers 548 in this path avoid potential race conditions and deadlocks in the remapping of FULL_RET to clock quiescence for the functional components in this path/group.

The distribution of the power mode request for logic retention in this manner thus allows components to be addressed in order from left to right: Ingress GPU Q-channel 570; GPU-TBU Q-Channel 572; Targets to CPU; FH Q-Channel 574; Egress to GPU Q-Channel 576; F/L to Egress to FH CRG Q-Channel 578; and F/L to Egress to GPU CRG Q-Channel 580, respectively, within partition 504, as shown, in a manner that preserves their context to provide software transparency while avoiding use of the OFF or quiescence (QSTOPPED) power mode of these components when implementing logic retention. Avoiding use of the OFF or quiescence (QSTOPPED) power mode of these components prevents triggering initialization or invalidation sequences that can cause context loss or excessive start-up time, or both.

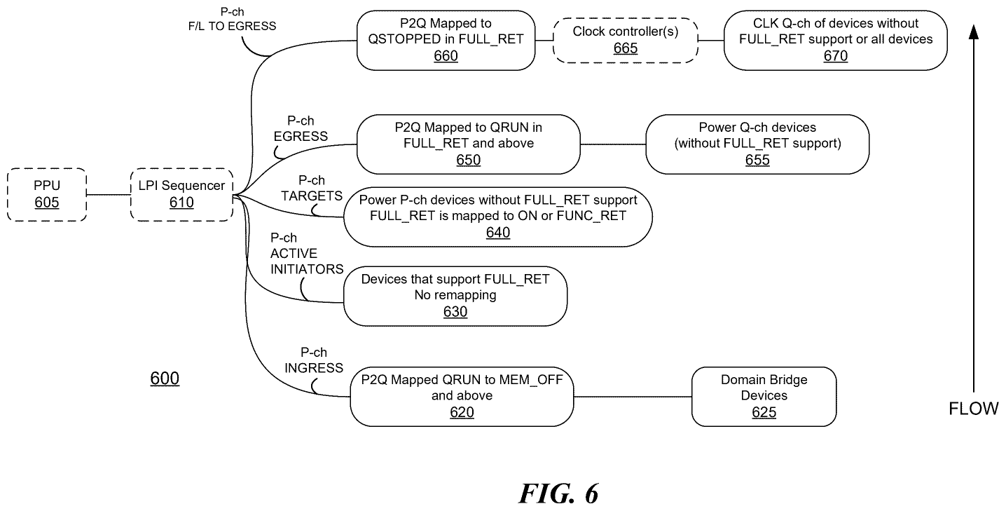

FIG. 6 is a diagrammatic representation 600 of a mechanism for entering a logic retention mode in a power domain of a data processing system, in accordance with an embodiment of the present disclosure. While the order of operations may vary, the flow line indicates that the flow proceeds first with the Ingress path, then Active Initiators, Targets Egress and finally F/L to Egress, e.g. from higher to lower power mode, e.g. ON to FULL_RET, as previously described. As shown in FIG. 6, the power domain power controller, shown here as PPU 605 in an example embodiment, may transmit a logic retention power mode request to a distribution unit, such as a lower power LPI sequencer 610 in this example embodiment. LPI sequencer 610 may map and distribute (sequence) the logic retention power mode request to the functional units or devices, referred to also as components, from bottom to top as shown by the flow line in FIG. 6 starting with the components in the Ingress path, followed by the Active Initiators, Targets, Egress, and FL/L to Egress paths.

The LPI sequencer 610 may provide the logic retention power mode request with instructions to convert from P2Q (P-channel to Q-channel) with mapped QRUN to MEM_OFF and above at 620. These instructions may be implemented for domain bridge components at 625, such as using domain bridges 552 and/or 560 shown in FIG. 5.

The LPI sequencer 610 may provide the logic retention power mode request to components that support FULL_RET instructions without remapping (630) (or without mapping/remapping instructions). As previously described and shown with reference to FIG. 1, such components include LRPM supporting components 150 and power domain boundary crossing control components 140.

The LPI sequencer 610 may provide the logic retention power mode request to power P-ch components without FULL_RET support. In this instance, FULL_RET is mapped to ON or FUNC_RET at 640. These functional units or components are described herein as non-LRPM supporting components 160 as previously described and shown with reference to FIG. 1.

The LPI sequencer 610 may provide the logic retention power mode request with instructions for performing P2Q (P channel to Q-channel). The request may be mapped to QRUN in FULL_RET and above at 650. Power continues to be supplied to Q-channel components without FULL_RET support at 655.

For the non-LPRM supporting components 160, the LPI sequencer 610 may provide the logic retention power mode request with instructions for performing P2Q. The P-channel request may be mapped to a QSTOPPED in FULL_RET Q-channel request at 660. In response to the Q-channel request, the clock controllers are signaled at 665 to drive the non-LPRM supporting components 160 to a quiescent state. The Q-channel clock may be retained for components without FULL_RET support or for all components at 670.

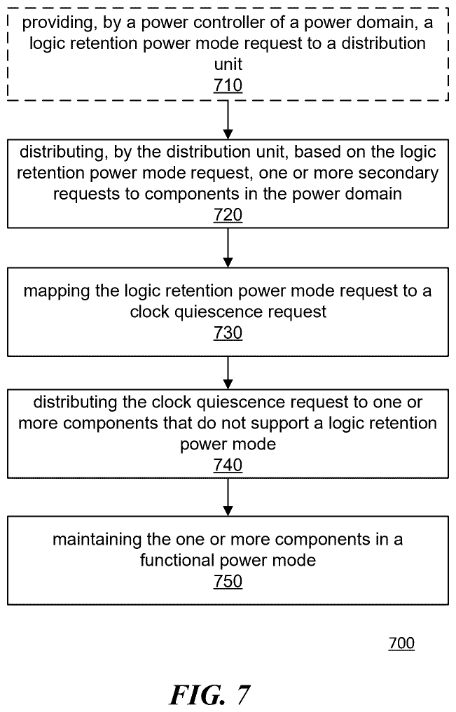

FIG. 7 depicts a flowchart 700 of a method of logic retention support in a data processing system, in accordance with an embodiment of the present disclosure.

At block 710, a power controller (for example, power controller 110 that may be implemented as a PPU in certain embodiments) of a power domain 130 provides a logic retention power mode request to distribution unit 120, which may be a sequencing unit. Block 710 is optional (shown as a dashed box), such as in the case where a logic retention power mode request has already been received by the distribution unit.

At block 720, distribution unit 120, based on the logic retention power mode request, distributes one or more secondary requests to functional units in the power domain. These functional units may include PDBCC components 140, LRPM supporting components 150, and non-LPRM supporting components 160.

At block 730, the logic retention power mode request is mapped to a clock quiescence request for the non-LPRM supporting components 160.

At block 740, the clock quiescence request is distributed to one or more of the functional units that do not support a logic retention power mode (for example, the non-LPRM supporting components 160).

At block 750, these functional units (for example, non-LPRM supporting components 160) are maintained in a functional power mode.

Embodiments of the present disclosure advantageously provide a method and system for implementing logic retention support in a data processing system. The embodiments described above and summarized below are combinable.

In one embodiment of a method of implementing logic retention support in a data processing system, the method includes distributing, based on a logic retention power mode request, one or more secondary requests to functional units in the power domain. Said distributing includes: mapping the logic retention power mode request to a clock quiescence request; distributing the clock quiescence request to one or more first functional units of the functional units that are without a logic retention power mode; and maintaining the one or more first functional units in a functional power mode.

In another embodiment of the method, the method includes distributing the logic retention power mode request to one or more second functional units that support the logic retention power mode.

In another embodiment of the method, the method includes distributing the logic retention power mode request to one or more third functional units that control power domain boundary crossings of the power domain; and mapping, for the one or more third functional units, the logic retention power mode request to a power quiescence request.

In another embodiment of the method, the method further includes sending, to the one or more first functional units, a request to enter one of an ON type functional power mode, an OFF type non-functional power mode, a memory retention power mode, or a power quiescence mode, where the request excludes an explicit clock quiescence request.

In another embodiment of the method, the method further includes applying said clock quiescence request to selected units of the one or more first functional units; and requesting the selected units to enter clock quiescence.

In another embodiment of the method, the method further includes driving, by clock controllers, in response to the clock quiescence request, the one or more first functional units to a clock quiescent state.

In another embodiment of the method, the method further includes providing the logic retention power mode request to a sequencing unit.

In one embodiment of a system, the system includes a power controller of a power domain configured to provide a logic retention power mode request to a distributor; and the distributor configured to: distribute one or more secondary requests to functional units in the power domain in response to receipt of the logic retention power mode request, said distributing further configured to: map the logic retention power mode request to a clock quiescence request; distribute the clock quiescence request to one or more first functional units of the functional units that are without a logic retention power mode; and maintain the one or more first functional units in a functional power mode.

In another embodiment of the system, the distributor is further configured to distribute the logic retention power mode request to one or more second functional units that support the logic retention power mode.

In another embodiment of the system, the distributor is further configured to: distribute the logic retention power mode request to one or more third functional units that control power domain boundary crossings of the power domain; and map, for the one or more third functional units, the logic retention power mode request to a power quiescence request.

In another embodiment of the system, the power controller is further configured to send, to the one or more first functional units, a request to enter one of an ON type functional power mode, an OFF type non-functional power mode, a memory retention power mode, or a power quiescence mode, where the request excludes an explicit clock quiescence request.

In another embodiment of the system, the power controller is further configured to send, to the one or more first functional units, a request to enter an “ON” mode, where the request excludes an explicit clock quiescence request.

In another embodiment of the system, the clock quiescence request is applied to selected units of the one or more first functional units; and the selected units are requested to enter clock quiescence.

In another embodiment of the system, the system also includes clock controllers configured to drive the one or more first functional units to a clock quiescent state in response to the clock quiescence request.

In another embodiment of the system, the distributor is a sequencer.

In one embodiment of a non-transitory computer-readable medium to store computer-readable code for fabrication of a logic retention support circuit of a data processing system, the logic retention support circuit configured to: receive a logic retention power mode request; distribute, based on the logic retention power mode request, one or more secondary requests to functional units in a power domain, said distributing further configured to: map the logic retention power mode request to a clock quiescence request; distribute the clock quiescence request to one or more first functional units of the functional units that are without a logic retention power mode; and maintain the one or more first functional units in a functional power mode.

In another embodiment of the computer-readable medium, the logic retention support circuit is further configured to distribute the logic retention power mode request to one or more second functional units that support the logic retention power mode.

In another embodiment of the computer-readable medium, the computer readable code includes code for fabrication of a logic retention support circuit further configured to distribute the logic retention power mode request to one or more third functional units that control power domain boundary crossings of the power domain, and map, for the one or more third functional units, the logic retention power mode request to a power quiescence request.

In another embodiment of the computer-readable medium, the computer readable code includes code for fabrication of a logic retention support circuit further configured to send, to the one or more first functional units, a request to enter one of an ON type functional power mode, an OFF type non-functional power mode, a memory retention power mode, or a power quiescence mode, where the request excludes an explicit clock quiescence request.

While implementations of the disclosure are susceptible to embodiment in many different forms, there is shown in the drawings and will herein be described in detail specific embodiments, with the understanding that the present disclosure is to be considered as an example of the principles of the disclosure and not intended to limit the disclosure to the specific embodiments shown and described. In the description above, like reference numerals may be used to describe the same, similar or corresponding parts in the several views of the drawings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive. Also, grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth. References to items in the singular should be understood to include items in the plural, and vice versa, unless explicitly stated otherwise or clear from the text.

Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” “for example,” or the like) provided herein, is intended merely to better illuminate the embodiments and does not pose a limitation on the scope of the embodiments. No language in the specification should be construed as indicating any unclaimed element as essential to the practice of the embodiments.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

In the following description, it is understood that terms such as “first,” “second,” “top,” “bottom,” “up,” “down,” “above,” “below,” and the like, are words of convenience and are not to be construed as limiting terms. Also, the terms apparatus, device, system, etc. may be used interchangeably in this text.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A method of implementing logic retention support in a data processing system, comprising:
distributing, based on a logic retention power mode request, one or more secondary requests to functional units in the power domain, said distributing including:
mapping the logic retention power mode request to a clock quiescence request;
distributing the clock quiescence request to one or more first functional units of the functional units that are without a logic retention power mode; and
maintaining the one or more first functional units in a functional power mode.

2. The method of claim 1, further comprising:
distributing the logic retention power mode request to one or more second functional units that support the logic retention power mode.

3. The method of claim 1, further comprising:
distributing the logic retention power mode request to one or more third functional units that control power domain boundary crossings of the power domain; and
mapping, for the one or more third functional units, the logic retention power mode request to a power quiescence request.

4. The method according to claim 1, further comprising:
sending, to the one or more first functional units, a request to enter one of an ON type functional power mode, an OFF type non-functional power mode, a memory retention power mode, or a power quiescence mode, where the request excludes an explicit clock quiescence request.

5. The method according to claim 1, further comprising:
applying said clock quiescence request to selected units of the one or more first functional units; and
requesting the selected units to enter clock quiescence.

6. The method according to claim 1, further comprising:
driving, by clock controllers, in response to the clock quiescence request, the one or more first functional units to a clock quiescent state.

7. The method according to claim 1, further comprising:
providing the logic retention power mode request to a sequencing unit.

8. A system, comprising:
a power controller of a power domain configured to provide a logic retention power mode request to a distributor; and
the distributor configured to:
distribute one or more secondary requests to functional units in the power domain in response to receipt of the logic retention power mode request, said distributing further configured to:
map the logic retention power mode request to a clock quiescence request;
distribute the clock quiescence request to one or more first functional units of the functional units that are without a logic retention power mode; and
maintain the one or more first functional units in a functional power mode.

9. The system according to claim 8, where the distributor is further configured to distribute the logic retention power mode request to one or more second functional units that support the logic retention power mode.

10. The system according to claim 8, where the distributor is further configured to:
distribute the logic retention power mode request to one or more third functional units that control power domain boundary crossings of the power domain; and
map, for the one or more third functional units, the logic retention power mode request to a power quiescence request.

11. The system according to claim 8, where the power controller is further configured to send, to the one or more first functional units, a request to enter one of an ON type functional power mode, an OFF type non-functional power mode, a memory retention power mode, or a power quiescence mode, where the request excludes an explicit clock quiescence request.

12. The system according to claim 8, where the power controller is further configured to send, to the one or more first functional units, a request to enter an “ON” mode, where the request excludes an explicit clock quiescence request.

13. The system according to claim 8, where said clock quiescence request is applied to selected units of the one or more first functional units; and
the selected units are requested to enter clock quiescence.

14. The system according to claim 8, further comprising clock controllers configured to drive the one or more first functional units to a clock quiescent state in response to the clock quiescence request.

15. The system according to claim 8, where the distributor is a sequencer.

16. A non-transitory computer-readable medium to store computer-readable code for fabrication of a logic retention support circuit of a data processing system, the logic retention support circuit configured to:
receive a logic retention power mode request;
distribute, based on the logic retention power mode request, one or more secondary requests to functional units in a power domain, said distributing further configured to:
map the logic retention power mode request to a clock quiescence request;
distribute the clock quiescence request to one or more first functional units of the functional units that are without a logic retention power mode; and
maintain the one or more first functional units in a functional power mode.

17. The non-transitory computer-readable medium according to claim 16, where the logic retention support circuit is further configured to distribute the logic retention power mode request to one or more second functional units that support the logic retention power mode.

18. The non-transitory computer-readable medium according to claim 16, where the computer readable code includes code for fabrication of a logic retention support circuit further configured to distribute the logic retention power mode request to one or more third functional units that control power domain boundary crossings of the power domain; and
map, for the one or more third functional units, the logic retention power mode request to a power quiescence request.

19. The non-transitory computer-readable medium according to claim 16, where the computer readable code includes code for fabrication of a logic retention support circuit further configured to send, to the one or more first functional units, a request to enter one of an ON type functional power mode, an OFF type non-functional power mode, a memory retention power mode, or a power quiescence mode, where the request excludes an explicit clock quiescence request.
